(19) United States
(12) Patent Application Publication
(10) Pub. No.: US 2008/0249776 A1
(43) Pub. Date: Oct. 9, 2008

(54) Methods and Arrangements for Enhancing Machine Processable Text Information

(75) Inventors: Reinhard Busch, Munich (DE); Gregor Thurmair, Munich (DE)

Correspondence Address: WOLF GREENFIELD & SACKS, P.C., 600 ATLANTIC AVENUE, BOSTON, MA, 02210-2206, US

(73) Assignee: Linguatec Sprachtechnologien GmbH, Munich (DE)

(21) Appl. No.: 11/885,689

(22) PCT Filed: Mar. 7, 2005
(86) PCT No.: PCT/EP05/02408

§ 371 Date: Apr. 23, 2008

(51) Int. Cl. G10L 13/08

(52) U.S. Cl. 704/260

(57) ABSTRACT

The invention relates to methods and arrangements for enhancing machine processable text information which is provided by at least machine processable text data. On the basis of synthetic speech, i.e. speech generated by a machine, prosody-related information and/or text-related information is determined and added to given text information.

The present invention relates to methods and arrangements for enhancing machine processable text information which is provided by at least machine processable text data.

Machine processable text data is typically processed by automated language processing arrangements, for example in the field of machine translation, to achieve a predetermined goal without user input, for example to translate the given text from a first language to a second language. Typically, the automated language processing arrangements rely on the text data which is given in such a form or format that the text data is machine readable and processable. By analyzing and evaluating the text data in great depth using sophisticated algorithms such automated language processing arrangements aim to optimize the processing result, for example the quality of the translated text in the second language. During the processing operation text data are used as a main source of information to perform typically morphological, syntactical and semantical analyses for determining the content of the given text and for processing the text in the light of the content. In spite of the quality achieved, the above automated language processing arrangements typically suffer from a lack of prosody-related information and additional text-related information which can only be gathered if the text in words spoken by a human being is taken into consideration. However, automated arrangements of the above kind intend to avoid user input, i.e. the need to involve the user in the processing operation.

From EP 0 624 865 A it is known to utilize prosody-related information in an arrangement for translating speech from a first language to a second language. The words spoken by a human being are received by a receiving element in a first language, a translation unit for translating the speech in the first language to a second language and speech synthesis elements for generating speech in the second language. Since the user provides the input of spoken words, the known arrangement can analyze the spoken words and determine prosody-related information. Apparently, the known arrangement takes advantage of direct user input, i.e. the spoken words, but fails to provide guidance for automated language processing arrangements where user input is to be avoided.

Other devices for speech synthesis and machine translation are known from EP 0 327 408 A and U.S. Pat. No. 4,852,170 comprising speech recognition and speech synthesis, however, without utilizing prosody-related information. Still further devices, which are known from EP 0 095 139 and EP 0 139 419, perform speech synthesis utilizing prosody-related information but do not relate to automated processing of machine processable text data, like for example machine translation.

The present invention aims to make available an improvement for automated language processing arrangements such that the machine processable text information is enhanced without additional user input.

According to a first aspect of the invention, the above aim is achieved by an arrangement for enhancing machine processable text information provided by at least machine processable text data comprising an audio signal data generating unit for generating audio signal data on the basis of said text data, an analyzing unit for analyzing said audio signal data for determining prosody-related information contained in said audio signal data and an information adding unit for adding said prosody-related information provided by said analyzing unit to said given machine processable text information. Further, the audio signal data generating unit comprises a speech synthesis unit for processing said text data and for generating speech on the basis of said text data and a audio signal data processing unit for processing said speech and for generating audio signal data in a machine processable form.

Still according to the first aspect of the invention, the above aim is furthermore achieved by a method for enhancing machine processable text information provided by at least machine processable text data comprising the steps of: generating audio signal data on the basis of said text data, analyzing said audio signal data for determining prosody-related information contained in said audio signal data and adding said prosody-related information provided by said analyzing step to said given machine processable text information. Further, the step of generating audio signal data comprises the steps of: processing said text data and generating speech on the basis of said text data as well as processing said speech and generating audio signal data in a machine processable form.

The above arrangement and method provide an enhancement of the given text information since prosody-related information is added thereto. According to the first aspect of the invention the additional information is provided on the basis of speech which is generated by speech synthesis, i.e. speech generated by a machine.

The solution according to the first aspect of the invention makes advantageously use of speech synthesis, in a way unrecognized to date, namely due to recognizing that speech synthesis, i.e. the machine based generation of speech on the basis of text data, has improved to an extend that reliable prosody-related information can be extracted from audio signal data representing a speech audio signal generated by speech synthesis. Thus, the invention opens an simple but efficient way of incorporating prosody-related information in any language or text processing system or arrangement dealing with machine processable text information without the need for a human reader to read out the given text in order to provide the speech audio signal.

According to second aspect of the invention, the above aim is achieved by an arrangement for enhancing machine processable text information provided by at least machine processable text data comprising an audio signal data generating unit for generating audio signal data on the basis of said text data, an speech recognition unit for analyzing said audio signal data for determining text-related information contained in said audio signal data and an information adding unit for adding said text-related information provided by said analyzing unit to said given machine processable text information. Further, the audio signal data generating unit comprises a speech synthesis unit for processing said text data and for generating speech on the basis of said text data and a audio signal data processing unit for processing said speech and for generating audio signal data in a machine processable form.

Still further according to the second aspect of the invention, the above aim is achieved by a method for enhancing machine processable text information provided by at least machine processable text data comprising the steps of: generating audio signal data on the basis of said text data, analyzing said audio signal data for determining text-related information contained in said audio signal data and adding said text-related information provided by said analyzing step to said given machine processable text information. Further, the step of generating audio signal data comprises the steps of: processing said text data and generating speech on the basis of said text data as well as processing said speech and generating audio signal data in a machine processable form.

The solution according to the second aspect of the invention enhances the given text information by adding additional text-related information which is obtained by speech recognition of speech generated by speech synthesis, i.e. speech generated by a machine.

Advantageous modifications of the arrangements and the methods according to the aspects of the invention are described in the subclaims.

The invention will be described in the following in greater detail and with reference to the drawings which show in

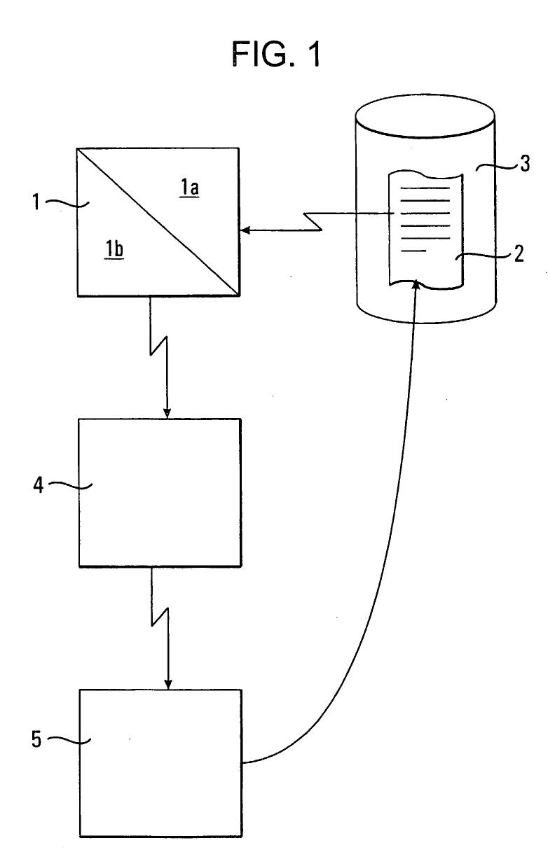

FIG. 1 a block diagram of a first embodiment of an arrangement according to the invention;

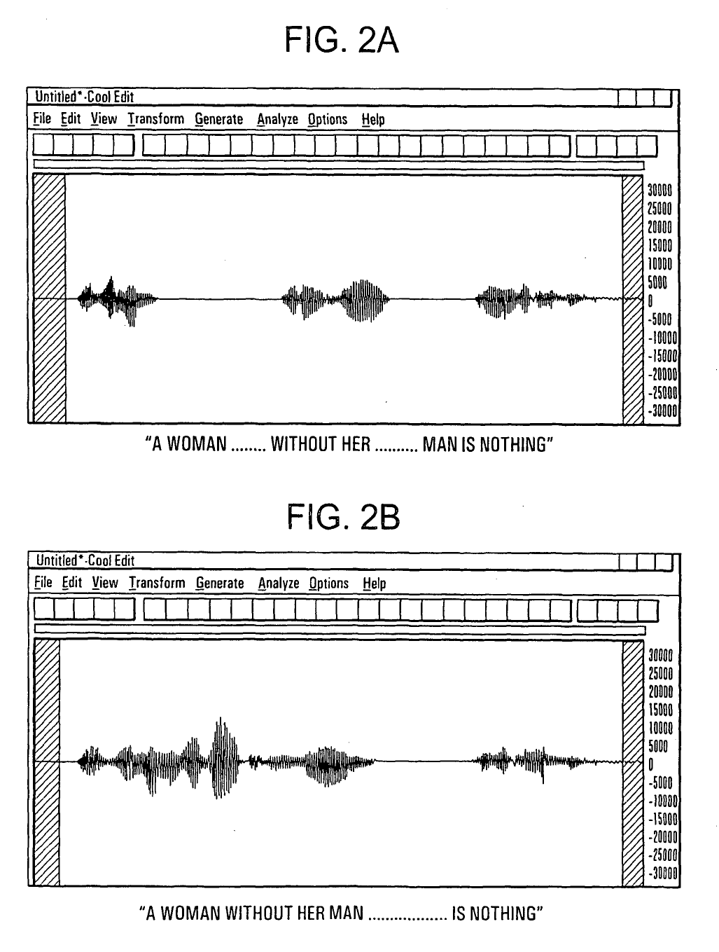

FIGS. 2A and 2B graphical representations of audio signal data expressing a first synthetically spoken sentence;

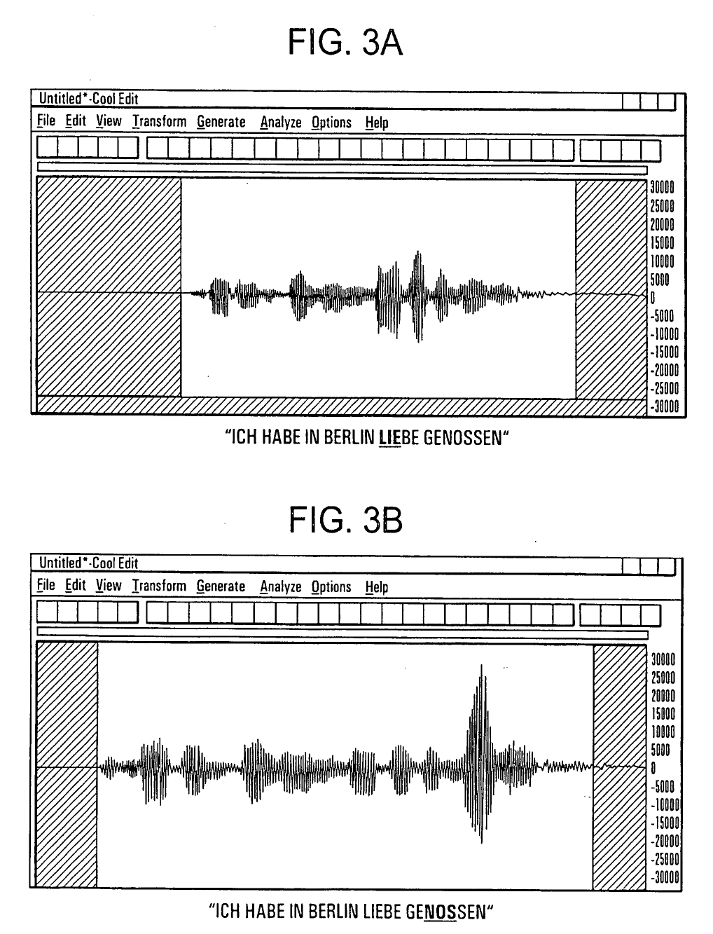

FIGS. 3A and 3B graphical representations of audio signal data expressing a second synthetically spoken sentence;

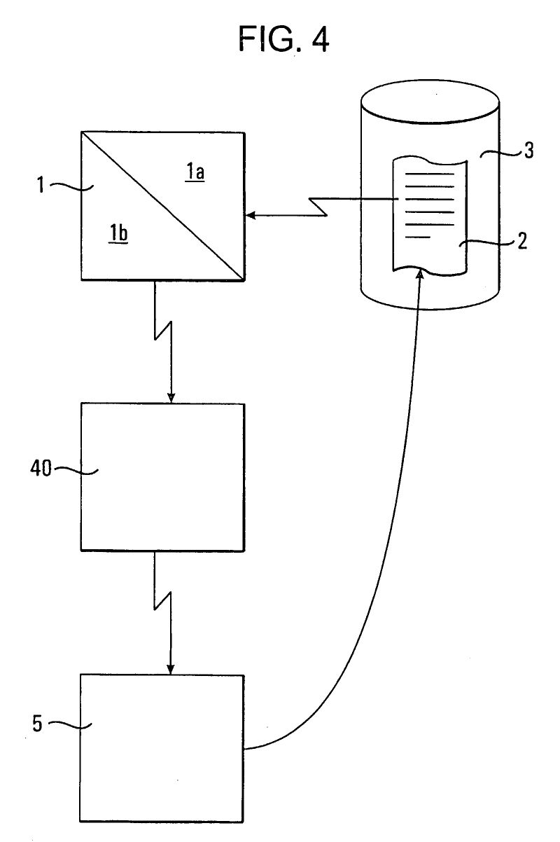

FIG. 4 a block diagram of a second embodiment of an arrangement according to the invention;

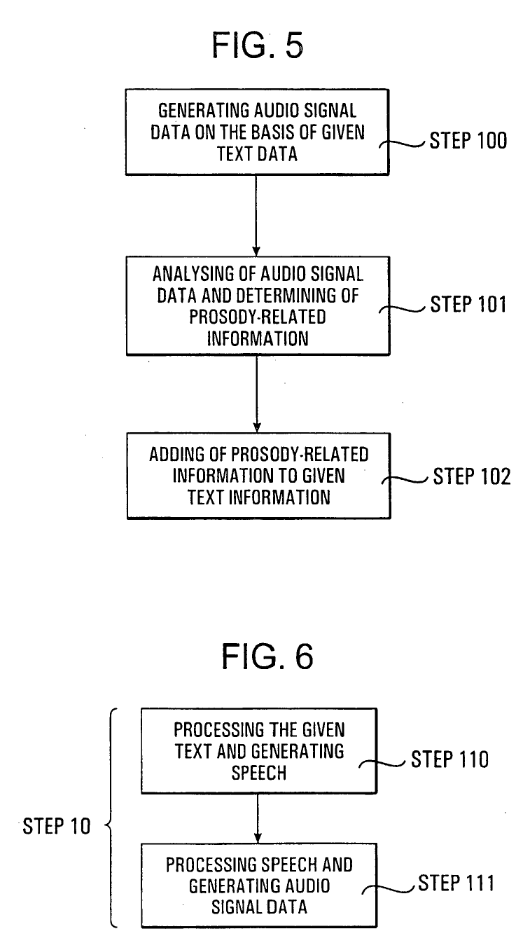

FIG. 5 a flow diagram of a first embodiment of method according to the invention;

FIG. 6 a flow diagram of a step of said first embodiment of method according to the invention; and

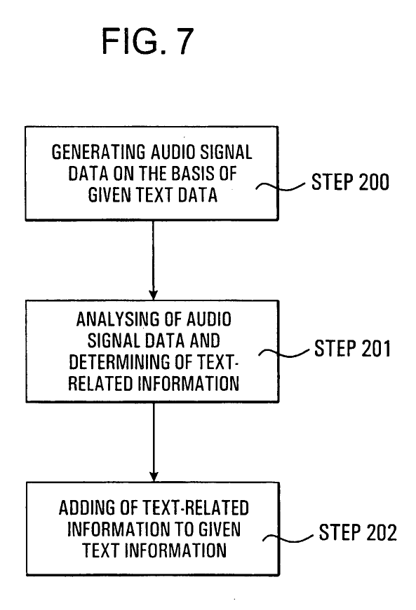

FIG. 7 a flow diagram of a second embodiment of method according to the invention.

FIG. 1 shows a first embodiment of an arrangement according to the invention for enhancing machine processable text information provided by at least machine processable text data. An example of machine processable text data is a data file stored on a storage device wherein said data file contains coded characters, for example according to ASCII or UNICODE.

The arrangement of FIG. 1 comprises an audio signal data generating unit 1 for generating audio signal data on the basis of said text data which is preferably stored in a data file 2 on a storage device 3. Further, the arrangement according to the invention comprises an analyzing unit 4 that receives the audio signal data from said generating unit 1. The analyzing unit 4 analyses said audio signal data for determining prosody-related information contained in said audio signal data. Further, the arrangement according to the invention comprises an information adding unit 5 that receives the prosody-related information from said analyzing unit 4 and adds said prosody-related information to said given machine processable text information, preferably by storing said prosody-related information on the storage device 3, preferably in the same data file 2. Thereby, the machine processable text information is enhanced since prosody-related information is added to it. The enhancement is achieved without user input.

According to the invention and as shown in FIG. 1, the audio signal data generating unit 1 comprises a speech synthesis unit 1a for processing said text data and for generating speech on the basis of said text data and a audio signal data processing unit 1b for processing said speech and for generating audio signal data in a machine processable form. In one example, the speech synthesis unit 1a is a speech synthesizer comprising an amplifier and a loudspeaker to generate an audible signal and the audio signal processing unit 1b is a recorder comprising a microphone and an encoder to pick up the audible signal and to encode the synthetic speech audio signal in a machine processable data format. In a preferred example, as indicated in FIG. 1, the speech synthesis unit 1a and the audio signal data processing unit 1b are provided in a combined manner such that said audio signal data in a machine processable form are generated directly without the intermediate generation and recording of an audible signal.

The speech synthesis unit 1a generates speech containing prosody information by virtue of the speech synthesis technology. The audio signal data also contains this additional information so that a respective analysis can be carried out to retrieve prosody-related information for being added to the given text information. It should be noted that the retrieval of such prosody-related information can be performed according to principles similar to the principles used for generating the speech provided by said speech synthesis unit 1a but it is preferred according to the invention to perform the analysis of the audio signal data according to principles which are adjusted to the intended automated machine processing of the text information, for example the above mentioned machine translation. Therefore, the principles of said analysis typically differ from the principles of said synthesis.

The prosody-related information as determined by said analyzing unit 4 may comprise information regarding the intonation, the fundamental tone, the frequency, the magnitude or the rhythm of the speech as expressed in the audio signal data. Furthermore, pauses and discontinuities may be determined and analyzed.

The above audio signal generating unit 1, the analyzing unit 4, information adding unit 5 as well as the speech synthesis unit 1a and the audio signal data processing unit 1b of the preferred example are preferably provided by means of software or programs which are executed on a computer comprising said storage device 3 for storing data files 2.

FIG. 2A shows a graphical representation of a first example of audio signal data expressing the synthetically spoken sentence: “A woman without her man is nothing”. By analyzing the audio signal data with respect to pauses and discontinuities the prosody-related information can be determined that the synthetically spoken sentence comprises three parts and that there are pauses behind the parts “a woman” and “without her”. In some contrast, FIG. 2B shows a graphical representation of a second example of audio signal data expressing the same synthetically spoken sentence: “A woman without her man is nothing”. Now, however, by analyzing the audio signal data with respect to pauses and discontinuities the prosody-related information can be determined that the synthetically spoken sentence comprises two parts and that there is pause behind the parts “a woman without her man”.

FIG. 3A shows a graphical representation of a third example of audio signal data expressing the synthetically spoken sentence: “ICH HABE IN BERLIN LIEBE GENOSSEN”. By analyzing the audio signal data, for example with respect to intonation and magnitude, the prosody-related information can be determined that the synthetically spoken sentence comprises emphasis on the word “LIEBE”. In some contrast, FIG. 3B shows a graphical representation of a forth example of audio signal data expressing the synthetically spoken sentence: “ICH HABE IN BERLIN LIEBE GENOSSEN”. Now, however, by analyzing the audio signal data, for example with respect to intonation and magnitude, the prosody-related information can be determined that the synthetically spoken sentence comprises emphasis on the word “GENOSSEN”.

Obviously, the such prosody-related information determined on the basis of synthetically generated speech adds valuable information to the text information for further content related processing.

FIG. 4 shows a second embodiment of an arrangement according to the invention for enhancing machine processable text information provided by at least machine processable text data. Similar to the first embodiment, the arrangement according to the second embodiment of the invention comprises an audio signal data generating unit 1 for generating audio signal data on the basis of said text data which is preferably stored in a data file 2 on a storage device 3. In contrast to the first embodiment, the arrangement according to the second embodiment of the invention comprises an speech recognition unit 40 that receives the audio signal data from said generating unit 1 analyzing said audio signal data for determining text-related information contained in said audio signal data an the basis of speech recognition technology. Again similar to the first embodiment, the arrangement according to the second embodiment of the invention comprises an information adding unit 5 that receives the text-related information from said speech recognition unit 40 and adds said additional text-related information to said given machine processable text information, preferably by storing said text-related information on the storage device 3, preferably in the same data file 2. Thereby, the machine processable text information is enhanced since further text-related information is added to it. The enhancement is achieved without user input.

Since the audio signal data generating unit 1 according to the second embodiment of the invention is similar to the first embodiment, reference is made to the above description of the audio signal data generating unit 1.

The speech recognition unit 40 according to the second embodiment preferably performs speech recognition and provides text-related information, especially text data representing the speech of the audio signal data in a machine processable form or format. During the process of speech recognition further text-related information may become available since powerful speech recognition relies on large vocabularies and improved techniques and algorithms, for example the Hidden Markov Model (HMM) along with bi- and trigram statistics based on a text corpus of several million words. Such powerful speech recognition provides vectors indicating alternative word candidates for any recognized word. This vector of recognition alternatives can be utilized as additional text-related information to be added to the given text information according to the second embodiment of the invention.

Further, the processing of orthographical errors in the given text information can be improved in the automated processing of the given text, since text-related information according to the second embodiment of the invention may also comprise correctly recognized words. The correctness of the recognition is due to the fact that powerful speech recognition relies on sophisticated techniques and algorithms. For example, a powerful speech recognition system will correctly recognize the incorrectness in given texts like “Er hatte es fass nicht geschafft.” or “He didn't quiet make it.” and will provide the additional text-related information in the corrected speech “Er hatte es fast nicht geschafft.” or “He didn't quite make it.”, respectively by taking into account the context of the given text.

Obviously, the such text-related information determined on the basis of synthetically generated speech adds valuable information to the text information for further content related processing.

The above audio signal generating unit 1, the analyzing unit 40, information adding unit 5 as well as the speech synthesis unit 1a and the audio signal data processing unit 1b of the preferred example are provided by means of software or programs which are executed on a computer comprising said storage device 3 for storing data files.

FIG. 5 shows a flow diagram illustrating a first embodiment of a method according to the invention for enhancing machine processable text information provided by at least machine processable text data. In Step 100 audio signal data is generated on the basis of said given text data. In Step 101 said audio signal data are analyzed for determining prosody-related information contained in said audio signal data. In Step 102 said prosody-related information provided by said analyzing Step 101 is added to said given machine processable text information.

Further, as shown in FIG. 6 the Step 100 of generating audio signal data comprises Steps 110 and 110. In Step 110 said text data is processed and speech is generated on the basis of said text data. In Step 111 said speech is processed and audio signal data is generated in a machine processable form.

The prosody-related information as determined in Step 101 may comprise information regarding the intonation, the fundamental tone, the frequency, the magnitude or the rhythm of the speech as expressed in the audio signal data. Furthermore, pauses and discontinuities may be determined and analyzed.

FIG. 7 shows a flow diagram illustrating a second embodiment of a method according to the invention for enhancing machine processable text information provided by at least machine processable text data. In Step 200 audio signal data is generated on the basis of said given text data. In Step 201 said audio signal data are analyzed for determining text-related information contained in said audio signal data. In Step 202 said text-related information provided by said analyzing Step 201 is added to said given machine processable text information.

Further, reference is made to FIG. 6 and the corresponding description above as the Step 200 of generating audio signal data comprises Steps 110 and 111.

The methods according to the first and second embodiment of the invention may be carried out by software or programs executed on a computer comprising a storage device for storing data files.

Obviously, the prosody-related information and the text-related information determined by either one of the analyzing units 4 and 40 can be added both to the given text information. Accordingly, a single analyzing unit is provided in a still further preferred embodiment of the invention, said single analyzing unit determining prosody-related information and text-related information.

The invention can be embodied by a computer system executing software or program causing said computer to operate according to a method of anyone of the above methods of the first and second embodiments of the invention.

Said computer software or program can be stored on a computer readable media. Therefore, the invention can be embodied by a computer readable media carrying information thereon representing a software or program which, when executed on a computer, causes said computer to operate to a method of anyone of the above methods of the first and second embodiments of the invention.

1. Arrangement for enhancing machine processable text information provided by at least machine processable text data comprising:
an audio signal data generating unit for generating audio signal data on the basis of said text data comprising
a speech synthesis unit for processing said text data and for generating speech on the basis of said text data and
an audio signal data processing unit for processing said speech and for generating audio signal data in a machine processable form
an analyzing unit for analyzing said audio signal data for determining prosody-related information contained in said audio signal data, and
an information adding unit for adding said prosody-related information provided by said analyzing unit to said given machine processable text information.

2. Arrangement according to claim 1, wherein the prosody-related information comprises information regarding the intonation, the fundamental tone, the frequency, the magnitude or the rhythm of the speech as well as pauses and discontinuities within the speech or any combination of anyone thereof.

3. Arrangement according to claim 1, wherein said speech synthesis unit and said audio signal data processing unit are provided in a combined manner.

4. Method for enhancing machine processable text information provided by at least machine processable text data comprising the steps of:
generating audio signal data on the basis of said text data comprising the steps of:
processing said text data and generating speech on the basis of said text data and
processing said speech and generating audio signal data in a machine processable form
analyzing said audio signal data and determining prosody-related information contained in said audio signal data, and
adding said prosody-related information provided by said analyzing step to said given machine processable text information.

5. Method according to claim 4, wherein the prosody-related information comprises information regarding the intonation, the fundamental tone, the frequency, the magnitude or the rhythm of the speech as well as pauses and discontinuities within the speech or any combination of anyone thereof.

6. Arrangement for enhancing machine processable text information provided by at least machine processable text data comprising:
an audio signal data generating unit for generating audio signal data on the basis of said text data comprising
a speech synthesis unit for processing said text data and for generating speech on the basis of said text data and
an audio signal data processing unit for processing said speech and for generating audio signal data in a machine processable form
a speech recognition unit for analyzing said audio signal data for determining text-related information contained in said audio signal data and
an information adding unit for adding said text-related information provided by said speech recognition unit to said given machine processable text information.

7. Arrangement according to claim 6, wherein the text-related information comprises information regarding the text content of said audio signal data.

8. Arrangement according to claim 6, wherein the text-related information comprises information relating to vectors of recognition alternatives of words recognized by said speech recognition unit.

9. Arrangement according to claim 6, wherein said speech synthesis unit and said audio signal data processing unit are provided in a combined manner.

10. Method for enhancing machine processable text information provided by at least machine processable text data comprising the steps of:
generating audio signal data on the basis of said text data comprising the steps of:
processing said text data and generating speech on the basis of said text data and
processing said speech and generating audio signal data in a machine processable form
analyzing said audio signal data and determining text-related information contained in said audio signal data and
adding said text-related information provided by said analyzing step to said given machine processable text information.

11. Method according to claim 10, wherein the text-related information comprises information regarding the text content of said audio signal data.

12. Method according to claim 10, wherein the text-related information comprises information relating to vectors of recognition alternatives of words recognized by said speech recognition step.

13. Computer system executing software causing said computer to operate according to a method of claim 4.

14. Computer readable media carrying information thereon representing a software or program which, when executed on a computer, causes said computer to operate to a method of claim 4.

15. Computer system executing software causing said computer to operate according to a method of claim 10.

16. Computer readable media carrying information thereon representing a software or program which, when executed on a computer, causes said computer to operate to a method of claim 10.
